(19) United States
(12) Patent Application Publication
(10) Pub. No.: US 2018/0029761 A1
(43) Pub. Date: Feb. 1, 2018

(54) OBTURATION DEVICE FOR RECEPTACLE COMPRISING A SYSTEM FOR CHECKING VIOLATION THEREOF

(71) Applicant: COMMISSARIAT A L'ENERGIE ATOMIQUE ET AUX ENERGIES ALTERNATIVES, Paris (FR)

(72) Inventor: Jean-François Mainguet, Grenoble (FR)

(73) Assignee: COMMISSARIAT A L'ENERGIE ATOMIQUE ET AUX ENERGIES ALTERNATIVES, Paris (FR)

(21) Appl. No.: 15/550,531

(22) PCT Filed: Feb. 12, 2016
(86) PCT No.: PCT/EP2016/053036

§ 371 Date: Aug. 11, 2017

(30) Foreign Application Priority Data
Feb. 17, 2015 (FR) 1551299

(51) Int. Cl. B65D 55/02; B65D 79/02; B65D 51/24

(52) U.S. Cl. CPC B65D 55/028; B65D 51/245; B65D 55/026; B65D 79/02; B65D 2101/00; H04Q 2209/47

(57) ABSTRACT

An obturation device (10) intended to obturate an opening (12) of a container (11) comprises a checking system configured to detect any extraction of the obturation device (10) from the opening (12), particularly in case of violation of the obturation device (10). The checking system has at least one sensor (13) determining the value taken by at least one physical quantity representative of a behavior of one of the parts of the obturation device (10) forming a support for the sensor (13), and an electronic processing unit (14) receiving the value of the physical quantity determined by the sensor (13) and modifying a state variable when the value exceeds a predetermined threshold. The modification of the state variable is determined by the electronic processing unit (14). The invention also relates to a container (11) whose opening is obturated by such an obturation device (10).

### TECHNICAL FIELD OF THE INVENTION

The invention relates to an obturation device intended to obturate an opening of a container and comprising a checking system configured to detect any extraction of the obturation device from the opening, particularly in case of violation of the obturation device.

Also a subject of the invention is a container whose opening is obturated by such an obturation device.

### STATE OF THE ART

Some products, mainly high value liquids such as spirits for example, or even medicines, are regularly the subject of counterfeiting.

To this end, the counterfeiter obtains a container having contained the original product, fills it with a product of lower quality and recloses the container by means of an obturation device, possibly the original one.

If this re-stoppering operation has been implemented with enough care, it may not be visible to the subsequent consumer.

Systems based on radio-identification have been developed in order to make it possible to reveal a fraudulent re-stoppering of a container. These systems implement a radio protection tag comprising an electronic chip and an antenna, arranged on a thin support. In the existing systems, the tag is arranged such that an attempt to open the stopper is necessarily reflected in a disturbance or an at least partial destruction of the tag. The duly modified tag no longer operates and in particular is no longer capable of communication with a radio-identification transceiver. It is therefore possible, by means of such a transceiver, to detect that the original stopper has been violated.

Such a solution is simple and inexpensive because it makes it possible to dispense with the need for an electrical power supply. However, the protection conferred remains basic and can be refined in terms of reliability. The existing systems present the drawback of it being generally possible, if acting with precaution, to dissociate the radio-identification tag and the stopper from the container, without affecting the integrity of the tag. Thus, once the container is filled with the product of lower value, the counterfeiter can replace the original stopper and the tag. Since the latter has not been damaged, it is not possible to detect such a fraudulent re-stoppering.

### OBJECT OF THE INVENTION

One aim of the invention is to design an obturation device which does not present the abovementioned drawbacks and which is in particular more reliable and more robust than the existing systems while remaining inexpensive and simple to design, manufacture and implement.

This aim can be achieved through an obturation device intended to obturate an opening of a container and comprising a checking system configured to detect any extraction of the obturation device from the opening, particularly in case of violation of the obturation device, the checking system comprising, on the one hand, at least one sensor determining the value taken by at least one physical quantity representative of a behavior of one of the parts of the obturation device, said at least one physical quantity comprising the acceleration and, on the other hand, an electronic processing unit receiving the value of the physical quantity determined by the sensor and modifying a state variable when the value of the physical quantity determined by the sensor exceeds a predetermined threshold, the modification of the state variable being determined by the electronic processing unit.

The predetermined threshold can be known to the electronic processing unit.

Said at least one physical quantity can comprise the acceleration undergone by the support of the sensor in the area of the support where the sensor is mounted.

The support of the sensor can be configured so as to produce a mechanical amplification of acceleration between the acceleration undergone by the obturation device and the acceleration determined by the sensor over at least a part of the extraction of the obturation device from the opening.

Said at least one physical quantity can comprise a deformation undergone by the support in the area where the sensor is mounted.

Said at least one physical quantity can comprise the mechanical stresses undergone by the support in the area where the sensor is mounted.

The checking system can comprise, on the one hand, an information storage unit communicating with the electronic processing unit and making it possible to save any modification of the state variable and, on the other hand, a communication unit, such as a radio-identification tag antenna, communicating with the information storage unit and/or with the electronic processing unit and making it possible to communicate any modification of the state variable to the outside of the obturation device.

The obturation device can be configured in such a way that any extraction of the obturation device from the opening of the container automatically provokes a characteristic and predetermined modification of the behavior of a first part of the obturation device, such as a displacement and/or a deformation and/or a mechanical stressing of the first part, the modification of the behavior being such that it is necessarily accompanied by a variation of the physical quantity determined by the sensor inducing the modification of the state variable.

The first part undergoing the characteristic and predetermined modification of behavior can exhibit elasticity properties such that the extraction of the obturation device from the opening provokes an elastic return of the first part to a final configuration adopted at the end of the extraction of the obturation device from the opening.

The extraction of the obturation device from the opening can provoke, in succession:

an elastic deformation of the first part under the effect of the extraction of the obturation device from the opening, from an initial configuration occupied before its elastic deformation,

said elastic return of the first part to its final configuration, during which the value of the physical quantity determined by the sensor exceeds the predetermined threshold,

the successive implementation of the elastic deformation and of the elastic return corresponding to the characteristic and predetermined modification of the behavior of the first part.

In the initial configuration adopted before the extraction of the obturation device, the first part can be deformed elastically in relation to a configuration of rest of the first part and the extraction of the obturation device from the opening can provoke only the elastic return of the first part varying the first part from said initial configuration to the final configuration, the implementation of this elastic return corresponding to the characteristic and predetermined modification of the behavior of the first part.

The support on which the sensor is mounted can consist of the first part.

The obturation device can comprise a second part situated on the path of the first part during its elastic return to its final configuration, so as to constitute an abutment in the movement of the first part.

The support on which the sensor is mounted can consist of the second part.

The obturation device can comprise a stressing member arranged so as to:

stress the first part, by physical contact with the first part,

abruptly relax said stress, by interruption of the physical contact between the first part and the stressing member, provoking the elastic return of the first part to its final configuration during which the value of the physical quantity determined by the sensor exceeds the predetermined threshold.

The obturation device can comprise first and second parts of which at least one is intended to be arranged at least partially inside the opening of the container to obturate it in a seal-tight manner, said parts being secured to one another while allowing a relative displacement of the first part in relation to the second part at least when a pulling force intended to extract the device from the opening is applied to said device, the support belonging to one of said parts and the stressing member belonging to the other of said parts.

The obturation device can be configured such that the value determined by the sensor exceeds the predetermined threshold if the pulling force is greater than a predetermined force threshold for which the device has been designed, preferentially greater than the weight of the container comprising the obturation device.

The stressing member can progressively stress the first part during a first predetermined travel of the displacement in translation and possibly in rotation of the first part during the extraction of the obturation device, and the relaxing of the stress is performed by the stressing member when the displacement of the first part is prolonged beyond said first predetermined travel.

Prior to the extraction of the obturation device and before any displacement of the first part, the stressing member can already stress the first part.

The obturation device can comprise elements for rotationally immobilizing the first and second parts in relation to one another about an axis oriented in the direction of extraction of the obturation device from the opening and immobilizing the stressing member in its position where it stresses the first part.

A container can comprise an opening obturated by such an obturation device.

### BRIEF DESCRIPTION OF THE DRAWINGS

Other advantages and features will emerge more clearly from the following description of particular embodiments of the invention given as nonlimiting examples and represented in the attached drawings, in which:

FIG. 1 is a cross-sectional view of a first example of obturation device according to the invention,

FIG. 2 is a plan view of the support and of the sensor used in the solution of FIG. 1,

FIG. 3 is a cross-sectional view of a second example of obturation device according to the invention,

FIG. 4 is a plan view of the support and of the stressing member 17 used in the solution of FIG. 3, before and during the placement of the stressing,

FIGS. 5 to 7 represent, in cross section, a third example of obturation device according to the invention, in three successive configurations adopted during the extraction of the obturation device,

FIG. 8 is a schematic illustration of an example of checking system that can be used in the devices of the preceding figures.

### DESCRIPTION OF PREFERENTIAL EMBODIMENTS OF THE INVENTION

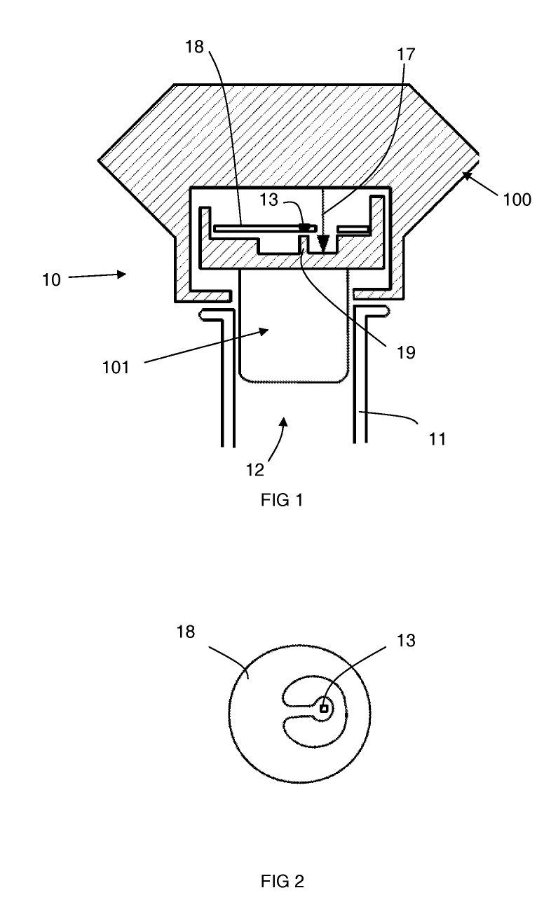

Generally, and referring to FIGS. 1 to 8, the invention relates to an obturation device 10 intended to obturate an opening 12 of a container 11 and comprising a checking system configured to detect any extraction of the obturation device 10 from the opening 12, particularly in case of violation of the obturation device.

The invention also relates to a container 11 whose opening 12 is obturated by such an obturation device 10.

One application that is particularly targeted and for which the solution described is particularly well suited relates to a container 11 consisting of a bottle intended to contain a liquid, in particular a liquid of high value such as alcohol, and equipped with an opening 12 formed by the neck of the bottle. However, this field of application is still not exclusive and can relate to the containers intended to contain medicines, scents, cosmetics, cigars or any other product to be protected, the containers of firearm loader type, extinguishers, or any other container with a single opening.

For simplicity, the rest of the description and the figures are associated only with the particular case of a bottle intended to contain a liquid and for which the violation of its opening (for example in order to modify the liquid) is checked by the checking system of the obturation device then placed at least partly in the neck of the bottle in order to obturate it in a seal-tight manner.

The checking system to this end comprises, on the one hand, at least one sensor 13 determining the value taken by at least one physical quantity representative of a mechanical behavior of one of the parts of the obturation device 10, this part for example consisting of a support for the sensor 13, and, on the other hand, an electronic processing unit 14 receiving the value of the physical quantity determined by the sensor 13 and modifying a state variable when the value of the physical quantity determined by the sensor 13 exceeds a predetermined threshold. The checking system is configured such that the modification of the state variable is determined by the electronic processing unit 14. The state variable can be formed in any electronic, binary or analog way.

In a first variant as represented, the sensor 13 and the electronic processing unit are dissociated elements located at different locations within the obturation device. In a second variant not illustrated, it is possible to provide for the sensor 13 and the electronic processing unit 14 to be formed in one and the same element and located at a same location within the obturation device, for example in the case where the sensor 13 and the electronic processing unit are organized on one and the same electronic chip. In the latter case, the reference 14 will be considered to be merged with the reference 13 in the figures.

According to a particular embodiment particularly in the case where the implementation of the predetermined threshold is performed by electronic or electromechanical means, the predetermined threshold is known to the electronic processing unit 14. This is not however limiting, particularly in the case where the implementation of the predetermined threshold is performed by mechanical means.

According to an embodiment that is particularly advantageous and effective in the aim sought, this at least one physical quantity comprises the acceleration undergone by a component of the obturation device 10, for example the support of the sensor 13 in the area of the support where the sensor 13 is mounted. In this case, the sensor 13 will consist of an accelerometer which can be of any nature provided that it is suited to the implementation of the operation described in this document.

Preferentially, in the latter case, the support of the sensor 13 is configured so as to produce a mechanical amplification of acceleration between the acceleration undergone by the obturation device 10 (particularly under the effect of a pulling force F applied to all or part of the obturation device 10 at the moment of its extraction to open the opening 12) and the acceleration determined by the sensor 13 over at least a part of the extraction of the obturation device 10 from the opening 12. Any technique that is known and suited to achieving this function can be envisaged for the implementation thereof.

Alternatively or in combination, said at least one physical quantity can comprise a deformation undergone by the support of the sensor 13 in the area of the support where the sensor 13 is mounted, and/or the mechanical stresses undergone by the support of the sensor 13 in the area of the support where the sensor 13 is mounted. In both these cases, the nature of the sensor 13 will be able to be adapted accordingly, for example by taking the form of strain or deformation gauges. The support of the sensor 13 can thus be deformable and/or mobile relative to the obturation device 10.

The sensor 13 can provide for the implementation of the predetermined threshold and the monitoring of the exceeding thereof to be performed by electronic, electromechanical or mechanical means.

When the implementation of the predetermined threshold is performed by mechanical means, the sensor 13 can for example comprise a weight that is mobile over a predetermined travel of displacement and mechanical means for stressing the weight in opposition to its displacement. The mechanical stressing means consist, for example, of a magnet or of a spring. The weight establishes an electrical contact at the end of its predetermined travel of displacement. The displacement of the weight is provoked by the movement, in particular the acceleration, undergone by the sensor 13 as a whole and is performed in opposition to the action of the mechanical stressing means. As an example, the electrical contact established by the weight provokes an interruption on a microcontroller which previously was in a standby state. The displacement of the weight beyond the predetermined travel corresponds to the exceeding of the predetermined threshold by the physical quantity measured by the sensor 13. The implementation of the predetermined threshold and the monitoring of the exceeding thereof by the physical quantity measured by the sensor 13 are performed mechanically in this example.

The implementation of the predetermined threshold and the monitoring of the exceeding thereof by the physical quantity measured by the sensor 13 can alternatively be performed by electronic or electromechanical means. In particular, these electromechanical means of the sensor 13 can be produced on the basis of electromechanical microsystems or “MEMS” (microelectromechanical systems). As an example, a comb is mounted on a spring with a test weight or body. When the comb is displaced in relation to the base under an effect of an acceleration, the electrical capacitance changes and this effect is measured. The variation of the capacitance beyond a predetermined value corresponds to the exceeding of the predetermined threshold by the physical quantity (here the acceleration) measured by the sensor 13. One advantage of this solution is its great robustness.

The two examples presented above offer the additional advantage of a very low energy consumption. They can require the presence of an electrical energy source 20 or not, particularly in the case where mechanical means are used. The saving of the modification of the state variable can be done mechanically, for example via an immobilization of the weight at the end of its predetermined travel of displacement, or electrically, for example via a fuse.

According to one embodiment and referring to FIG. 8, the checking system can advantageously comprise, on the one hand, an information storage unit 15 communicating with the electronic processing unit 14 and making it possible to save any modification of the state variable and, on the other hand, a communication unit 16, such as a radio-identification tag antenna, communicating with the information storage unit 15 and/or with the electronic processing unit 14 and making it possible to communicate any modification of the state variable to the outside of the obturation device 10. It becomes possible, from the outside of the obturation device 10, to observe any modification of the state variable, thus making it possible to detect a theoretical prior opening of the obturation device 10.

According to an embodiment that can be envisaged, the checking system will be able to comprise the electrical energy source 20 cited previously and that makes it possible to power its various sensors, in particular the sensor 13, as well as the electronic processing unit 14. It will also be able to comprise a complementary part, not powered by the energy source 20 and, on the contrary, autonomous, and comprising the information storage unit 15 and the communication unit. For example, this complementary part will be able to be formed by all or part of a radiofrequency tag of RFID (radio frequency identification) type: its electrical power supply will come from the stressing signal from the outside of the obturation device.

Preferentially, the obturation device 10 is configured such that any extraction of the obturation device 10 from the opening 12 of the container 11 automatically provokes a characteristic and predetermined modification of the mechanical behavior of a first part 18 of the obturation device, such as a displacement and/or a deformation and/or a mechanical stressing of the first part 18, the modification of the behavior being such that it is necessarily accompanied by a variation of the physical quantity determined by the sensor 13 inducing the modification of the state variable. The choice of the nature of the physical quantity and of the nature of the sensor 13 as presented previously will obviously be made according to the nature of the characteristic and predetermined modification of the mechanical behavior of the first part 18.

Each of the three examples of obturation device 10 thus comprises such a first part 18, perfectly identifiable at least in FIGS. 1, 3 and 5. In these examples, the first part 18 is configured so as to undergo a modification of mechanical behavior of elastic deformation type, in exchange for an elastic return at the moment of the end of its stressing by a stressing member 17 presented later.

Thus, according to one embodiment, the first part 18 undergoing the characteristic and predetermined modification of behavior exhibits elasticity properties such that the extraction of the obturation device 10 from the opening 12 provokes an elastic return of the first part 18 to a final configuration adopted at the end of the extraction of the obturation device 10 from the opening 12.

In particular, provision can be made for the extraction of the obturation device 10 from the opening 12 to successively provoke:

an elastic deformation of the first part 18 under the effect of the extraction of the obturation device 10 from the opening 12, from an initial configuration occupied before its elastic deformation,

said elastic return of the first part 18 to its final configuration, during which the value of the physical quantity determined by the sensor 13 exceeds the predetermined threshold,

the successive implementation of the elastic deformation and of the elastic return corresponding to the characteristic and predetermined modification of the behavior of the first part 18.

Such an operation is implemented in the first example of FIGS. 1 and 2 and in the third example of FIGS. 5 to 7.

For the first example, before the application of the extraction force F, the first part 18 is in a natural configuration of rest (FIG. 1), corresponding to the initial configuration. When this force is applied, the first part 18 will be elastically deformed under the action of the stressing member 17. This involves the elastic deformation described above. At the moment when the stressing of the member 17, which is substantially in the form of a hook, ceases, particularly when it goes beyond the first part 18 during its displacement and thus frees the first part 18, the latter effects its elastic return to its final configuration.

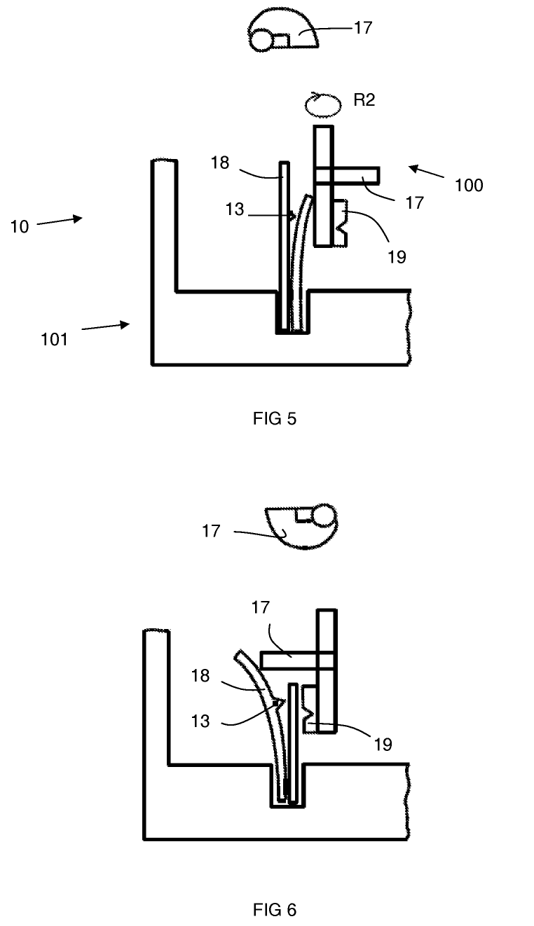

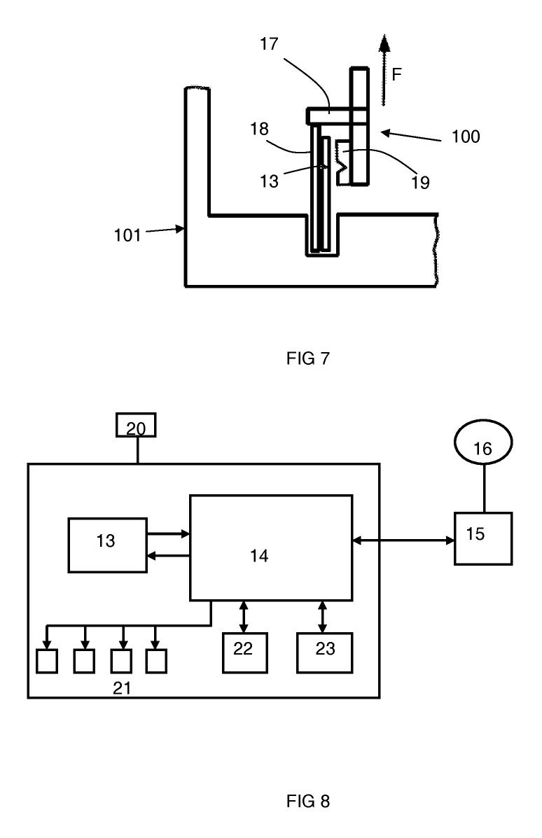

For the third example, before the application of the extraction force F, the first part 18 is in a natural configuration of rest (FIG. 5), corresponding to the initial configuration. The stressing member 17 does not apply stress to the first part 18. Then, before the application of the extraction force F, a rotation R2 is applied to the stressing member 17, in particular to all the part 100 detailed later. This rotation of the stressing member 17 involves the elastic deformation of the first part 18 explained previously (FIG. 6). Then, the force F is applied, involving a relative translational movement between the stressing member 17 and the first part 18. At the moment when the stressing of the member 17 ceases (FIG. 7), particularly when it goes beyond the first part 18 during its displacement and thus frees the first part 18, the latter effects its elastic return to its final configuration.

Alternatively, in the initial configuration adopted before the extraction of the obturation device 10, provision can be made for the first part 18 to be already elastically deformed in relation to a natural configuration of rest of the first part 18. The extraction of the obturation device 10 from the opening 12 then provokes only the elastic return of the first part 18, varying the first part 18 from this initial configuration to the final configuration. The implementation of this elastic return corresponds to the characteristic and predetermined modification of the behavior of the first part 18.

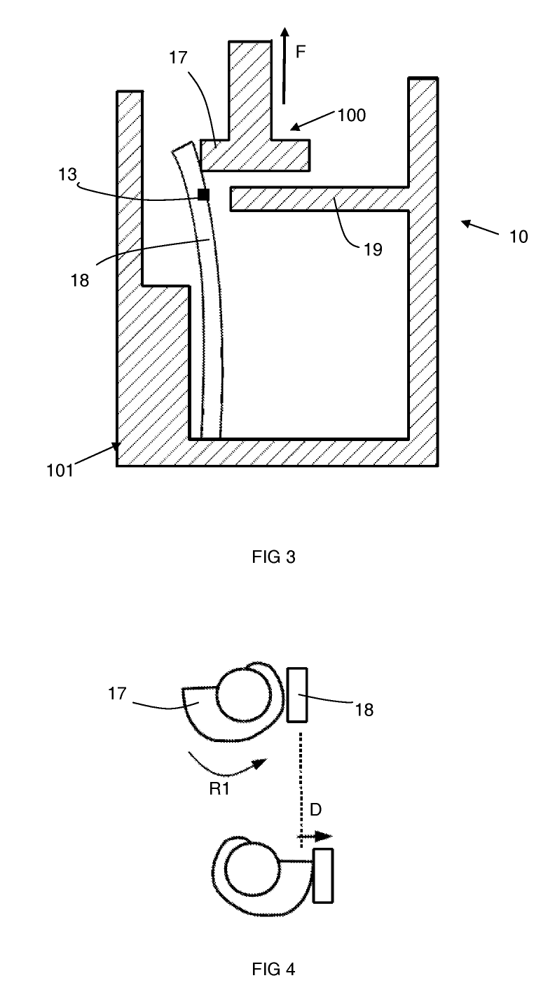

Such an operation is implemented in the second example of FIGS. 3 and 4. For the second example, before the application of the extraction force F, the first part 18 is already in its initial configuration (FIG. 3) in which it is elastically deformed under the action of a stress applied to the first part 18 by the stressing member 17 following a rotation R1 applied to the stressing member 17, and in particular to the part 100. This initial configuration is therefore distinct from a natural configuration of rest of the first part 18. FIG. 4 shows these differences in detail, in plan view. The top and bottom parts of FIG. 4 show the situations respectively before and after the rotation R1 applied to the stressing member 17. Before the implementation of the rotation R1, the stressing member 17 does not apply stress to the first part 18 and the latter occupies its natural configuration of rest. Then, before the application of the extraction force F, the rotation R1 is applied to the stressing member 17, in particular to all the part 100, involving the elastic deformation of the first part 18 explained previously (bottom part of FIG. 4) and a local displacement D of the first part 18. Then, the extraction force F is applied, involving a relative translational movement between the stressing member 17 and the first part 18. At the moment when the stressing of the member 17 ceases (FIG. 7), notably when it goes beyond the first part 18 during its displacement and thus frees the first part 18, the latter effects its elastic return to its final configuration, corresponding substantially to the natural configuration of rest.

According to a particular but in no way limiting embodiment, the support on which the sensor 13 is mounted consists of the first part 18.

The obturation device 10 can optionally comprise a second part 19 situated on the path of the first part 18 during its elastic return to its final configuration, so as to constitute an abutment in the movement of the first part 18 during the elastic return. That makes it possible to create an abrupt impact between the first part 18 and the second part 19, that can be detected more easily and that improves its detection reliability when the physical quantity determined by the sensor 13 is the acceleration, in particular by raising the value of the predetermined threshold known to the electronic processing unit 14.

In this particular case, it will be possible for the support on which the sensor 13 is mounted to consist of the second part 19, although it can consist of the first part 18 in all cases (with or without the second part 19).

As indicated previously, the obturation device 10 comprises a stressing member 17 arranged so as to:

stress the first part 18, by physical contact with the first part 18,

abruptly relax this stress, by interruption of the physical contact between the first part 18 and the stressing member 17, provoking the elastic return of the first part 18 to its final configuration during which the value of the physical quantity determined by the sensor 13 exceeds the predetermined threshold.

The nature of the stressing member 17 is unimportant as such and any type of stressing member can moreover be used provided that it is suited to the function described in this document.

In all the examples thus described, it is understood that the obturation device 10 uses the first part 18 acting as a spring stretched or tensed via the stressing member 17. Provision can be made for the action of tensioning of the spring by the member 17 to be implemented only at the moment of the extraction of the device 10 and result from the action of the force F (case of the first example) and possibly additionally from the rotation R2 (case of the third example): the mechanical energy necessary for the variation of behavior of the first part 18 is provided by the user performing the extraction of the device 10. Alternatively, provision can be made for the action of tensioning of the spring by the member 17 to be performed permanently within the device 10, even before the start of the extraction of the device 10 (case of the second example): the mechanical energy necessary for the variation of behavior of the first part 18 is incorporated in and borne by the device 10.

In each of the examples illustrated, but without that being limiting, the obturation device 10 comprises first and second parts 100, 101 of which at least one is intended to be arranged at least partially inside the opening 12 of the container 11 to obturate it in a seal-tight manner. These parts 100, 101 are secured to one other (at least axially) while allowing a relative displacement of the first part 100 in relation to the second part 101 at least when the pulling force F intended to extract the obturation device 10 from the opening 12 is applied to the obturation device 10. In this organization, the support on which the sensor 13 is mounted belongs to one of the parts 100, 101 and the stressing member 17 belongs to the other of the parts 100, 101. In the three examples of FIGS. 1 to 7, the support on which the sensor 13 is mounted, also consisting of the first part 18 as defined previously, belongs to the second part 101 whereas the stressing member 17 belongs to the first part 100. It is clear that a reverse arrangement can perfectly well be envisaged, in which the support on which the sensor 13 is mounted would belong to the first part 100 whereas the stressing member 17 would belong to the second part 101.

In addition, the first part 18 and the second part 19 can in particular belong to the same parts 100 or 101 of the obturation device 10: in the three examples of FIGS. 1 to 7, the parts 18 and 19 belong for example to the second part 101.

In the first and third examples, the stressing member 17 progressively stresses the first part 18 during a first predetermined travel of the displacement in translation and possibly in rotation (case only of the third example of FIGS. 5 to 7) of the first part 100 in relation to the second part 101 during the extraction of the obturation device. The relaxing of the stress is performed by the stressing member 17 when the displacement of the first part 100 is prolonged (particularly in translation in the direction of the pulling force F) in relation to the second part 101 beyond this first predetermined travel (at the moment when the stressing member 17 goes beyond and frees the first part 18 to allow its elastic return to the final configuration).

Alternatively, prior to the extraction of the obturation device 10 and before any displacement of the first part 100, the stressing member 17 already stresses the first part 18. Such is the case of the second example of FIGS. 3 and 4.

In this latter particular case, it will be advantageous to provide for the obturation device 10 to comprise elements for rotationally immobilizing (not represented as such and which can be of any nature) the first and second parts 100, 101 in relation to one another about an axis oriented in the direction of extraction of the obturation device from the opening and immobilizing the stressing member 17 in its position where it stresses the first part 18.

For a better reliability of the violation detection, the obturation device 10 is potentially configured such that the value determined by the sensor 13 exceeds the predetermined threshold if the pulling force F is greater than a predetermined force threshold for which the obturation device 10 has been designed, preferentially greater than the weight of the container (including its content, for example the liquid) comprising the obturation device 10.

The checking system will be able to comprise, particularly in the part supplied with energy by the source 20, light indicators 21, brightness detectors 22 or moisture and temperature detectors 23 to monitor the state of packaging of the container 11 over time, prior to the opening thereof. A temperature detector 23 makes it possible in particular to check that the checking system has not been exposed for certain periods to very low temperatures, which would be likely to render the electrical energy source 20 inoperative and the checking system inactive.

Provision can be made to protect the information storage unit 15 containing the opening detection trace when the modification of the state variable has occurred. For example, it is possible to erase a code in memory in case of detection of the opening, or to destroy a fuse irreversibly in order to render the whole useless if the container 11 has been opened.

The obturation device 10 therefore addresses the drawbacks of the solutions known currently and is in particular more reliable and more robust than the existing systems while remaining inexpensive and simple to design, manufacture and implement.

In particular, once the sensor 13 is triggered, it will reactivate the unit 14 so as to store the event in the unit 15, for example an RFID memory which will be able to be reread by external means.

One advantage of this solution is also the electrical consumption: only the sensor 13 keeps watch, and the setting of a detection threshold arbitrarily and deliberately high since it is possible to manage to provoke a significant impact (much greater than a single blow on the container 11), via the scaling down conferred by the behavior of the first part 18 and optionally by the presence of the second part 19, and therefore a very high acceleration. The discrimination will be easy and reliable in relation to the usual hazards to which a container 11 is conventionally subject.

1. An obturation device intended to obturate an opening of a container and comprising a checking system configured to detect any extraction of the obturation device from the opening wherein the checking systemcomprises:
at least one sensor determining the value taken by at least one physical quantity representative of a behavior of one of the parts of the obturation device, wherein the at least one physical quantity comprises the acceleration undergone, and
an electronic processing unit receiving the value of the physical quantity determined by the sensor and modifying a state variable when the value of the physical quantity determined by the sensor exceeds a predetermined threshold, the modification of the state variable being determined by the electronic processing unit.

2. The obturation device as claimed in claim 1, wherein the predetermined threshold is known to the electronic processing unit.

3. The obturation device as claimed in claim 1, wherein the at least one physical quantity comprises the acceleration undergone by the support of the sensor in the area of the support where the sensor is mounted.

4. The obturation device as claimed in claim 3, wherein the support of the sensor is configured so as to produce a mechanical amplification of acceleration between the acceleration undergone by the obturation device and the acceleration determined by the sensor over at least a part of the extraction of the obturation device from the opening.

5. The obturation device as claimed in claim 1, wherein the at least one physical quantity comprises at least one of (i) a deformation undergone by a support and (ii) a mobility of a support in the area where the sensor is mounted.

6. The obturation device as claimed in claim 1, wherein the at least one physical quantity comprises the mechanical stresses undergone by a support in the area where the sensor is mounted.

7. The obturation device as claimed in claim 1, wherein the checking system comprises, on the one hand, comprises:
an information storage unit communicating with the electronic processing unit and making it possible to save any modification of the state variable, and
a communication unit communicating with at least one of (i) the information storage unit and (ii) the electronic processing unit and making it possible to communicate any modification of the state variable to the outside of the obturation device.

8. The obturation device as claimed in claim 1, wherein the obturation device is configured so that any extraction of the obturation device from the opening of the container automatically provokes a characteristic and predetermined modification of the behavior of a first part of the obturation device, the modification of the behavior being accompanied by a variation of the physical quantity determined by the sensor inducing the modification of the state variable.

9. The obturation device as claimed in claim 8, wherein the first part undergoing the characteristic and predetermined modification of behavior exhibits elasticity properties such that the extraction of the obturation device from the opening (provokes an elastic return of the first part to a final configuration adopted at the end of the extraction of the obturation device from the opening.

10. The obturation device as claimed in claim 9, wherein the extraction of the obturation device from the opening provokes, in succession:
an elastic deformation of the first part under the effect of the extraction of the obturation device from the opening, from an initial configuration occupied before its elastic deformation,
said elastic return of the first part to its final configuration, during which the value of the physical quantity determined by the sensor exceeds the predetermined threshold,
the successive implementation of the elastic deformation and of the elastic return corresponding to the characteristic and predetermined modification of the behavior of the first part.

11. The obturation device as claimed in claim 9, wherein, in the initial configuration adopted before the extraction of the obturation device the first part is deformed elastically in relation to a configuration of rest of the first part and wherein the extraction of the obturation device from the opening provokes only the elastic return of the first part varying the first part from the initial configuration to the final configuration, the implementation of the elastic return corresponding to the characteristic and predetermined modification of the behavior of the first part.

12. The obturation device as claimed in claim 7, wherein a support on which the sensor is mounted consists of the first part.

13. The obturation device as claimed in claim 9, wherein the obturation device comprises a second part situated on the path of the first part during the elastic return to the final configuration, so as to constitute an abutment in the movement of the first part.

14. The obturation device as claimed in claim 13, wherein the support on which the sensor is mounted consists of the second part.

15. The obturation device as claimed in claim 9, wherein the obturation device comprises a stressing member arranged so as to:
stress the first part, by physical contact with the first part,
abruptly relax said stress, by interruption of the physical contact between the first part and the stressing member, provoking the elastic return of the first part to the final configuration during which the value of the physical quantity determined by the sensor exceeds the predetermined threshold.

16. The obturation device as claimed in claim 15, comprising first and second parts of which at least one is intended to be arranged at least partially inside the opening of the container to obturate the opening in a seal-tight manner, the first and second parts being secured to one another while allowing a relative displacement of the first part in relation to the second part at least when a pulling force intended to extract the device from the opening is applied to the device the support belonging to one of the first and second parts and the stressing member belonging to the other of the first and second parts.

17. The obturation device as claimed in claim 16, wherein the obturation device is configured such that the value determined by the sensor exceeds the predetermined threshold if the pulling force greater than a predetermined force threshold for which the device has been designed, preferentially greater than the weight of the container comprising the obturation device.

18. The obturation device as claimed in claim 16, wherein the stressing member progressively stresses the first part during a first predetermined travel of the displacement in translation and possibly in rotation of the first part during the extraction of the obturation device and the relaxing of the stress is performed by the stressing member when the displacement of the first part is prolonged beyond the first predetermined travel.

19. The obturation device as claimed in claim 16, wherein prior to the extraction of the obturation device and before any displacement of the first part the stressing member already stresses the first part.

20. The obturation device as claimed in claim 19, comprising elements for rotationally immobilizing the first and second parts in relation to one another about an axis oriented in the direction of extraction of the obturation device from the opening and immobilizing the stressing member in its the position where it the stressing member stresses the first part.

21. A container whose opening is obturated by an obturation device as claimed in claim 1.
